(19) United States
(12) Patent Application Publication
(10) Pub. No.: US 2024/0303120 A1
(43) Pub. Date: Sep. 12, 2024

(54) METHOD FOR HIGH-THROUGHPUT LOAD BALANCED DATA-PROCESSING IN DISTRIBUTED HETEROGENEOUS COMPUTING

(71) Applicant: Maurice Hendrikus Paulus van Putten, Seoul (KR)

(72) Inventor: Maurice Hendrikus Paulus van Putten, Seoul (KR)

(21) Appl. No.: 18/182,338

(22) Filed: Mar. 12, 2023

(51) Int. Cl. G06F 9/50

(52) U.S. Cl. CPC G06F 9/5027

(57) ABSTRACT

This invention pertains to optimizing data-analysis in distributed computing over a LAN or WAN of compute nodes. The method disclosed applies to processes that can be partitioned into tasks amenable to embarrassingly parallel compute. Reversing the traditional master-slave operation, this method introduces node-initiated task handling by synapses: scripts in daemon mode initiating requests for tasks specified by instructions in line items from a shared process list subject to atomic updating. This method realizes dynamical load balancing to compute-limited performance in heterogeneous distributed computing, when tasks have compute demands that are not predictable or nodes vary in compute performance. A particular objective is high-throughput signal-processing in time-critical processes, common in engineering and multi-messenger astronomy.

### CROSS-REFERENCES

HTCondor Team, 2021, HTCondor (V9.0.1); http://doi.org/10.5281/zenodo.4776257
Kim et al. “Dynamic Load Balancing using an Ant Colony Approach in Micro-cellular Mobile Communications Systems.” In: advances in Metaheuristics for Hard Optimization Natural; Computing, Series 2008, Copyright 2008, pp. 137-152 [online] [retrieved on Apr. 2, 2013; http://link.springer.com/chapter/10.1007/978-3-540-72960-0-7
MPI, 2023, https://en.wikipedia.org/wiki/Message_Passing_Interface
Sfiligoi, I., et al., “HTCondor data movement at 100 Gps”, In: 2021 IEEE 17th International Conference on eScience (eScience), 2021, pp. 239-240; https://doi.org/10.1109/eScience51609.2021.00040
van Putten, M. & Della Valle, M., 2023, Central engine of GRB170817A: Neutron star versus Kerr black hole based on multimessenger calorimetry and event timing, A&A 669 A36, https://doi.org/10.1051/0004-6361/202142974

### REFERENCE TO RELATED PATENTS

Hartman, D. S., et al., 2015, Decentralized distributed computing system, US20150074168A1

### ORIGIN OF THE INVENTION

Increasingly, the scientific process is data-intense, posing novel problems in high-performance computing (HPC). Existing hardware in laboratories common in academia in industry provides a potential for HPC on an ad-hoc platform for distributed computing at potentially zero upfront cost, provided dedicated software is in place realizing its compute-potential in aggregate. Working with existing hardware, such platform tends to be heterogeneous. Economizing heterogenous computing requires dynamical load balancing and avoiding bottlenecks in network I/O. Existing solutions largely based on the master-slave configuration are non-native to dynamical load balancing, however. Particularly for high-throughput data-analysis and signal processing challenges emerging in modern physics, astronomy and medical sciences, this invention discloses a software solution taking dynamical load balancing as the principle starting point for processes amenable to a fine grained partitioning into a large number of small tasks.

### FIELD OF THE INVENTION

This invention relates generally to high-throughput analysis of big data and signal processing encountered in science and engineering by distributed computing. A common scalable implementation is on heterogeneous compute platforms extending over a Local or Wide Area Network (LAN/WAN). Distributed computing over networks of this kind frequently comprise compute nodes with vastly different performance characteristics, distinct from traditional homogeneous cluster systems with nodes of the same type and performance.

Economizing compute platforms for high-throughput data-processing close to compute-limited performance is challenging for heterogeneous cluster systems, when node performance is not known or when compute demand is unpredictable. This challenge is crucial in low-latency (fast response) signal-processing. Examples are abound in multi-messenger analysis of transient phenomena in observational astronomy and multi-sensing and/or image analysis in engineering. The principle objective of the present invention is optimizing throughput in big data analysis and signal processing by distributed computing with dynamical load balancing on heterogeneous platforms with conventional network I/O bandwidths. It aims for near compute-limited performance in the face of nodes with different performance characteristics and/or data-processing with unpredictable compute demands using a new homogeneous task distribution technique with no master node, obviating the need for a central server, making use of existing hardware. While this disclosure aims for general purpose distributed computing, this invention applies in particular to processes which allow for fine-grained partitioning into tasks suitable for embarrassingly parallel compute. This class of problems includes, for instance, Monte Carlo simulations and signal-processing covering a dense or large space of parameters, relevant to simulations, observations and sensing.

A notable use-case is the exploitation of existing hardware in compute and networking across different generations, commonly encountered in laboratories in industry and academia. The present disclosure enables putting existing hardware to use at close to compute-limited performance, blind to the details of performance of each compute node, compute demand of individual tasks and I/O bandwidth over the network. This invention hereby significantly improves on the economic life-time of existing investments in computing hardware. Written in bash, this invention is highly portable across different Linux systems and light weight, facilitating rapid deployment with negligible learning curve or overhead.

### BACKGROUND OF THE INVENTION

Modern data-processing is increasingly compute intensive by data-size and demands on fast response. These processes emerge in physics and astronomy, engineering and medical sciences. A traditional approach to meeting these challenges is processing the application on a cluster of compute nodes at a computing center on campus or at a national computing center. While such can be a solution, it is not necessarily practical or economical in high throughput analysis with demands on low-latency. Data-flows readily exceed the bandwidth of Internet connections to a remote computing center. Also, this approach may lead to under-utilization of workstations in the laboratory over a LAN and/or collaborative laboratories over a WAN. In practical terms, a dedicated and in-house compute platform can outperform a remote system shared with many users once its performance reaches a certain fraction of that of the latter in time and expense. Yet, the number of existing workstations in the laboratory suitable for dual-use, as general purpose compute nodes and personal devices to employees, can be considerable. Their combined compute performance can meet aforementioned threshold, providing a solution at zero upfront cost provided they are networked into a distributed compute platform for big data-processing.

Parallel computing has long since been a method of choice to enhance compute performance, pioneered by the Message Parallel Interface (MPI) approach to harness the power of clusters of CPUs. High-throughput distributed computing over a network is highlighted by the open-source package HTCondor. In the face of distributed computing on a heterogeneous platform, however, maximal throughput requires dynamical load balancing and circumventing limitations of network bandwidth. Dynamical load balancing is native neither to MPI or HTCondor, even though such may be implemented on top of each implementation. For MPI, this can be attributed to the conventional use-case of a “homogeneous universe” of a network of identical compute nodes and operating systems. For HTCondor, this can be attributed to using the conventional master-slave configuration, where the master is defined by a central administrator running on a dedicated server. In addition to issuing tasks, also called jobs, the central administrator also services I/O to all compute nodes. On conventional networks, such centralized I/O can pose a bottleneck when the number of nodes is large or I/O is frequent. In a real-world environment of a network of heterogeneous compute nodes, therefore, these existing and similar approaches may under-perform, below the compute limit defined by the sum of all compute notes and their I/O bandwidth.

In this disclosure, we consider is the problem of economizing distributed computing over a heterogeneous network of compute nodes with arbitrary compute performance characteristics. The invention pertains to dynamical load balancing in big-data processing, allowing for a fine partitioning into relatively small tasks amenable to embarrassingly parallel compute. Our solution to dynamical load balancing considers a principle departure from the conventional master-slave configuration, wherein a master node acts as central manager issuing tasks, also called jobs, from a queue to slave nodes in the same cluster or network. This master-slave configuration tends to inhibit load balancing when the nodes have distinct performance characteristics and/or tasks have unpredictable compute demands, rendering it not suitable when economizing computing, aiming for high throughput and low latency.

This disclosure applies to processes partitioned into a Q relatively small tasks amenable to embarrassingly parallel computing. The tasks are described by line items in a Synaptic Process List (SPL) containing this partition. The process list of line items is prepared in advance by a user or machine generated by a previous process. An idle node ready to launch a task initiates a request to retrieve a line item from the SPL. SPL is accessed remotely over the network subject to atomic updating, ensuring each line item is received by exactly one node. For tasks whose run-time is long relative to the associated overhead in communication and input- and output-data handling, this Synaptic Parallel Processing (SPP) ensures each node is running continuously and, while the process list is not empty, all nodes are be busy. When the process list is empty, a few tasks in the tail of the initial process list may still be running to completion. This additional compute time will be small, provided that the initial length Q of the SPL is much greater than the task capacity of the network, defined by the total number of tasks that can be running concurrently. In the sense of distributed computing, SPP hereby realizes near compute-limited performance. This approach ensures most economic use of hardware, provided that a process allows for a sufficiently fine grained partitioning in tasks.

This disclosure describes SPP based on Synapses defined by a daemon initiating above-mentioned requests for line items from a SPL. The SPL is located in a base location (XSB) of the network. XSB can be anywhere, provided its known and accessible to the Synapses by remote access. XSB can be on one of the nodes or a Network Attached Storage (NAS), the latter illustrative for the fact that SPP obviates the need for a central server. Key to this invention is creating a network of Synaptic nodes: nodes running one or more Synapses, handling the requests for line items from the SPL and launching of tasks according to instructions therein, where SPL is subject to atomic updating. The details of this invention are disclosed in the next section.

To summarize, SPP offers a means for optimizing heterogeneous distributed computing for processes allowing fine grained partitioning into small tasks, amenable to embarrassingly parallel compute for the purpose of
Maximizing throughput and minimizing latency in big-data analysis and signal processing by dynamical load balancing in the face of vastly different performance characteristics of compute nodes and/or unpredictable runtime compute demands;
Economizing use of existing hardware, allowing workstations and personal computers to be networked with zero upfront costs into a high-performance distributed computing system;
Minimizing deployment time by general portability of bash scripts using standard ssh network utilities with no central server or master node and with zero upfront costs;
Enhancing security scaling by node-initiated launching of tasks with no login to the compute nodes, obviating disseminating node network addresses and login credentials.

### OBJECTS OF THE INVENTION

The first object is optimizing high-throughput in big-data analysis and signal processing on distributed heterogeneous computing at close to compute-limited performance of all nodes combined by dynamical load balancing. Blind to heterogeneity in node performance, this invention applies to processes allowing a fine grained partitioning of a process into smaller tasks amenable to embarrassingly parallel compute. Dynamical load balancing is realized by abandoning conventional master-slave configuration and, instead, delegating the distribution and launching of tasks by the nodes themselves. In this approach, nodes service their 1/O individually to NAS devices, obviating the need for a central server, enabling the network I/O bandwidth combined over all nodes to be effective.

A second object is realizing an economic solution to high-performance computing in a typical laboratory environment in industry and academia, having a fair number of workstations present for potential dual use as compute nodes and personal compute. Each node has one or more active Synapses defined by a daemon, handling remote requests for line items from the SPL over a LAN or WAN. Written in bash, these Synapses are highly portable with no interference to the existing workstation configurations and deployed with zero upfront cost.

A third object in economic use of existing hardware in high throughput distributed computing is minimizing deployment time. It is realized by Synapses: daemons written in bash on the nodes initiating requests for and launching tasks upon receiving synaptic instructions in line items from a located at a shared base point of the network. While SPL is not empty, performance in distributed computing is inherently compute-limited defined by the sum of the compute performance of all nodes. Upon exhausting the SPL, a tail of the original SPL may still be running. Upon completion thereof, all nodes return to idle. A user may then initiate a new process of the same kind by providing a new process list. Quite generally, processes may be run concurrently by initiating multiple SPLs with distinct names.

A fourth object is secure distributed computing, realized by obviating the need for login to any of the nodes and, hence, dissemination of node network addresses and login credentials. While security may not be critical in typical MPI-based parallel computing on a homogeneous cluster of nodes behind a fire-wall of a laboratory on-site, it inevitably becomes an issue of concern in distributed network computing. SPP naturally enables scaling to networks of arbitrary size by concurrency across sub-networks: distributed computing over a WAN comprising a plurality of LANs at different sites connected over the Internet. For rapid deployment, this network architecture is facilitated by putting the base point XSB in the cloud or on a desktop drive of a NAS, providing synchronized copies across each LANs. Maximal throughput will be preserved upon including a copy of the data-base of input data for a given process across each LAN, notably on a NAS, one for each LAN. Security can be extended to I/O on these NAS devices using reduced synaptic instructions in the line items of the SPL, restricted to runtime parameters, leaving network URL addresses and login credentials for I/O known to each LAN, out of view of the SPL and, hence, an external user. Preserving security, this requires copies of the input data to be present to the NAS of each participating LAN in advance.

### SUMMARY OF THE INVENTION

High-throughput distributed computing over a heterogeneous network of compute nodes generally calls for dynamical load balancing to economize a compute platform, measured by performance relative to theoretical compute-limited performance defined by the sum of compute-performance of all nodes. Conventional approaches to distributed computing build on the master-slave configuration, wherein a master node serves as a central administrator and submission node: (1) issuing tasks to slave nodes (also called workers) and (2) acting as the central gateway for I/O to NAS devices. A notable example is HTCondor in default configuration. However, such does not guarantee compute-limited performance without active runtime supervision of the status of each individual node and issuing new tasks to nodes that are determined to be idle and sufficient bandwidth to avoid bottlenecks in I/O when servicing a large number of nodes. Such active network supervision inevitably requires a central server with high-end I/O network interfacing to support all of the throughput in a given process.

The present invention turns this around, by enabling each individual node to take the initiative by means of Synapses: a daemon requesting for new tasks whenever it is idle from a SPL, line items in which providing the instructions for launching a new task. When the request is granted under the rules of atomic updating, a Synapse fetches a line item and removes it from the SPL. Atomic updating ensures that each line item task is processed by at most one node.

A principle operation of SPP is the distribution of tasks from a shared SPL by the nodes themselves, as opposed to the distribution of tasks by a central server or master node. This is realized by Synapses running as daemons on the nodes, tasked with retrieving the Synaptic instructions in line itemd from a SPL at a shared location a base point XSB in the network. A given node can run a plurality of Synapses, depending on its compute-performance. Notably, a large machine can run several, whereas a small machine may have just one Synapse. A Synapse is activated by its daemon, a script initialized with the required information to access the SPL, e.g., using the Secure Shell communication (ssh) to issue remote shell commands, a standard utility in computer networking. For instance, a SPL located on a NAS at given Local IP address of user Admin with password AdminPWD, the required access information can be stored in a bash readable fileXSB.dat on each node, containing:

XSB.dat: U=Admin;PWD=AdminPWD;IP=10.0.1.1:/volume1/XSB (1)

For a process A described by a SPL spelled out in a file A.xsi, consider an active Synapse m active on node n, querying and acting on A.xsi, located at a directory D=/volume1/XSB on the NAS at IP of (1) by remote Linux shell commands over ssh. Specifically, Synapse.n.m embodies the following steps:

while SPL is not empty do

Request exclusive access to SPL

If exclusive access is granted to Synapse n.m

then

Retrieve first Line Item from SPL Delete first Line Item from SPL

Release exclusive access from SPL

endif

Launch task according to newly retrieved Line Item

Wait for task to complete

done (2)

In this embodiment (2), each Synapse runs at most one task. To run multiple tasks concurrently on a high performance node, the node can be endowed with a plurality of active Synapses. In (2), exclusive access is realized by atomic updating of SPL, specific embodiments of which are given in the preferred embodiments section below.

A crucial advantage of disbanding the conventional master-slave configuration is security. Synapse-initiated task distribution and launching by nodes themselves circumvents the need for any external login to the nodes. In a maximally secure configuration, the SPL is stored outside the network, allowing the nodes themselves to remain hidden from view and remote access. This security advantage illustrates a distinct configuration and advantage compared to distributed computing based on a conventional master-slave configuration.

The invention for economic execution on distributed network of heterogeneous compute nodes applies to processes partitioned in tasks amenable to embarrassingly parallel computing. Instructions specifying a task are described by line items in a SPL. Nodes participate by one or more active Synapses: a daemon initiating requests to fetch line items containing the instructions to launch a new task from a SPL, updating the SPL by removing the corresponding line item and launching the new task according to the instructions in this line item. Specific steps defining these Synapses are exemplified in the following detailed disclosure, and the scope of the invention will be indicated in the claims.

### BRIEF DESCRIPTION OF DRAWINGS

For a more complete understanding of the invention, reference is made to the following description and accompanying drawings, in which:

FIG. 1 Is a schematic of distributed computing on a heterogeneous network of compute nodes. High-throughput data-analysis is realized for processes allowing a partitioning into tasks of smaller size, amenable to embarrassingly parallel computing facilitating dynamical load balancing. Instructions for tasks are specified as Line Items stored in a Synaptic Process List (SPL) stored at a base point XSB of the network with shared access, subject to atomic updating. Retrieving line items from SPL is initiated by Synapses, running as daemons on each node. If a request for a new line item is granted, a Synapse retrieves a line item from the SPL, removes it from the SPL, and launches a new task according to the instructions contained therein. Depending on compute-performance, nodes may have one or more Synapses. Tasks are launched and executed to completion until the SPL is empty.

### BEST MODE FOR CARRYING OUT THE INVENTION

The description of the preferred embodiment refers to big-data analysis and signal processing by distributed computing over a network of nodes, provided that the process allows a fine grained partitionion into a list of tasks amenable to embarrassingly parallel compute. Maximizing throughput by dynamical load balancing is realized by delegating the distribution and launching of tasks to the nodes themselves, by endowing nodes with Synapses defined by daemons. These Synapses requesting instructions to launch a new task specified in line items from an SPL located at a base location XSB in the network, where SPL is subject to atomic updating to ensure each task is evaluated by just one Synapse.

When a node is idle under the Synapse at hand, the Synapse requests a new line item and launching a task accordingly. Depending on compute-performance, a node can have a plurality of Synapses by running a multiple instances of these daemons. The maximum number of Synapses is set by the maximum number of concurrent tasks that a node can handle efficiently. The number of Synapses suitable for a node may also depend on the process at hand, determined by bench marking in advance. Near compute-limited performance in distributed computing over all nodes in the network will be realized, provided that the total number of tasks, defined by the length Q of the SPL, is much greater than the total number of Synapses. Synapses are initialized with the location and access credentials of the SPL at the base point XSB.

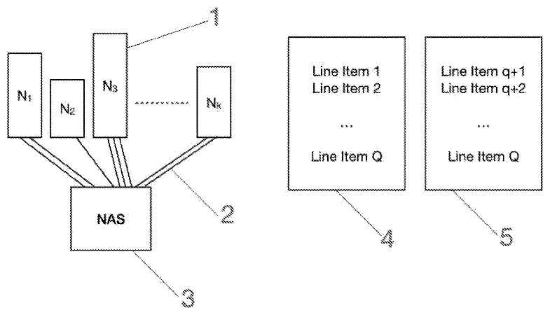

The arrangement in FIG. 1 shows an exemplary arrangement of a preferred embodiment applicable to distributed network of heterogeneous compute nodes interconnected over a LAN with Network Attached Storage (NAS). Highlighted are nodes Nᵢ (i=1, 2, . . . , k) by [1] with different numbers of synapses [2] according to their performance characteristics indicated by their size, connected into a LAN with NAS [3]. In FIG. 1, the XSB containing the SPL is hosted by the NAS.

The SPL contains an indexed list of line items, one for each task, amenable to embarrassingly parallel computing. Each line item represents the synaptic instructions (XSI) to launch a task on the distributed compute platform including network addresses for I/O. For a total of Q tasks, these XSIp indexed over p=1, 2, . . . , Q stipulate network location of input by EURL1, network location for output by EURL2 and run-time parameters PAR specific to the task at hand. In a preferred embodiment, the synaptic instruction line items are of the form

XSIₚ: p ProcessName EURL1 EURL2 PARₚ, (3)

(p=1, 2, . . . , Q), where EURL refers to a URL of the data storage device extended with the required access or login credentials and a designated directory therein. This data storage resource may be one of the compute nodes or a NAS device. Alternatively, this storage resource may be outside the LAN to facilitate scaling at the cost of possibly reduced data-transfer bandwidth. The inclusion of I/O network addresses sets Synaptic instructions (11) apart from existing approaches, where such is generally administrated by a central server, typically in a master-slave configuration.

In a preferred embodiment, SPL resides at a base point XSB in the network of compute nodes, which is on any one of the nodes or on a designated NAS. A process has a designated short-hand given by a capital letter. Advanced signal-processing may require analysis in steps over multiple processes. For instance, searches for signals deep in the noise of detector data require whitening by program A, producing spectrograms by a program B and image analysis by a program C. Respectively labeled A, B and C, the SPL with the line items (11) are files labeled

A.xsi, B.xsi, C.xsi, (4)

to be executed sequentially by SPP.

The arrangement in FIG. 1 further shows the SPL, initially with all Line Items p (p=1, 2, . . . , Q) defining the complete process to be executed [4]. A process is running while the process list is not yet empty. The number of line items in a process list gradually diminishes as p=(q+1, q+2, . . . , Q) after q line items have been retrieved by the Synaptic nodes in the network [5]. SPL is empty after q=Q line items have been fetched. The process completes when all nodes are idle, indicating all tasks have been completed. The network is then ready for a new process, starting by providing a new SPL. In processing (4), for instance, this refers to initiating B.xsi following completion of A.xsi, and initiating C.xsi following completion of B.xsi.

A preferred embodiment for atomic updating over a LAN by exclusive access in (2) is by renaming a file. In bash, this is the my command. The operating system handling storage guarantees that a file can have only one name at any given time. The system response to n Synapses a=1, 2, . . . , n concurrently requesting to rename file F.txt to Fa.txt ensures a unique outcome Fb.txt for some 1 b n. Synapse b hereby receives the system response: “F.txt successfully renamed to Fb.txt”, whereas Synapses a/=b receive the system response “error: file not found”. In (2), a preferred implementation for exclusive access to the SPL by Synapse n.m, therefore, in bash, is

mv F Fn.m (5)

In one preferred embodiment of exclusive udpating of SPL for a process A, F is the SPL given by A.xsi.

In a second preferred embodiment, F=status-A, a status file of a process A. (This file can be empty.) Permission to update A.xsi is granted to Synapse n.m if status-A.n.m exists and denied otherwise. For a Synapse n.m granted access, it is essential that following its update of A.xsi, defined by retrieving the top Line Item and reducing its size accordingly, (5) is reversed, i.e., Synapse n.m restores F to its original name,

mv Fn.m F (6)

allowing any of the other Synapses to proceed with their requests.

In a third preferred embodiment, SPP extends over a WAN comprising a plurality of sub-network LANs connected to the Internet. The XSB containing the SPL is located in the cloud. For instance, the XSB is a directory in a Cloud Storage Service, provided by a commercially available vendor or a directory in a desktop drive synchronized by an application running on a NAS. In this approach, it suffices to have the XSB accessible on one location per LAN. Synchronization hereby realizes a number of copies of XSB equal to the number of LANs comprising the WAN comprising the distributed network as a whole. Inevitably, however, latency in synchronization inhibits the direct application of (5-6). Instead, atomic updating of the SPL is realized by a full handshaking technique between Synapses initiating requests and a daemon Synaptic WAN (SWAN) issuing line items from the SPL, replacing (5-6). A Synapse.n.m initiates a requests by creating an empty file F.n.m.r in XSB, where the node index n now extends over all nodes in the WAN, irrespective of the LAN hosting it. To this end, the Synapse daemon script now includes the messaging:

Initiating requests by creating F.n.m.r as an empty file in XSB

Waiting to receive a line item from SPL in F.n.m issued by SWAN

Confirming receipt by creating F.n.m.f as an empty file in XSB. (7)

The shell script SWAN handling Synapse requests comprises the steps:

while SPL is not empty

do

if F.n.m.r exists

then

copy first line item from SPL into F.n.m

delete first line item from SPL

endif

wait until F.n.m.f exists

delete F.n.m.r

delete F.n.m

delete F.n.m.f

done (10)

Using one SWAN instance (10) suffices to realize scaling of distributed computing over an arbitrary number of computing sub-net LANs, each comprising one or mode compute nodes. In this third preferred embodiment, it can be advantageous to enhance security by the SPL containing reduced synaptic instruction line items of the form

XSIₚ′: p ProcessName PARₚ, (11)

translated to (11) in each sub-net by the Synapses to include EURL1-2 local to their hosting LAN. Keeping I/O of all tasks local to each LAN requires a copy of the data-base of input data to the process at hand to be copied to each LAN, e.g., into a NAS to each.

It will thus be seen that the objects set forth above, among those made apparent from the preceding description, are efficiently attained and, because certain changes may be made in carrying out the above method and in the construction(s) set forth without departing from the spirit and scope of the invention, it is intended that all matter contained in the above description and shown in the accompanying drawings shall be interpreted as illustrative and not in a limiting sense. It is also to be understood that the following claims are intended to cover all of the generic and specific features of the invention herein described and all statements of the scope of the invention which, as a matter of language, might be said to fall therebetween.

1. A method of Synaptic Parallel Processing (SPP) for high-throughput analysis of a process by heterogeneous distributed computing over a network, said process partitioned into tasks amenable to embarrassingly parallel processing by the compute nodes of said network with the property that said nodes are each endowed with at least one Synapse run by a daemon, said Synapse initiating requests for line items from a Synaptic Process List (SPL) at a shared base point XSB in said network, said SPL subject to atomic updating by at most one Synapse at any given time, said Synapse launching a task upon receiving a line item from said SPL according to the instructions specified in said line item, said Synapse waiting for completion of said task before initiating said requests anew, where said data-analysis continues until said SPL is empty and all nodes return to idle.

2. The method of SPP as described in claim 1 further comprising atomic updating of said SPL by said Synapse awaiting the existence of a file F in said XSB, said Synapse fetching said line item comprising:
said Synapse renaming F to a file name F.n.m unique to said Synapse m on node n;
updating said SPL comprising: antecedent
(a) retrieving the first line item;
(b) deleting said line item;
(c) renaming said F.n.m back to F;
launching the task defined by said newly retrieved line item; executing said new task to completion;
initiating a request for a subsequent task if said SPL is not empty.

3. The method of SPP as described in claim 1 further with the property that said instructions to launching a task includes the I/O network address specific to each said task including any required login credentials to NAS devices.

4. The method of SPP as described in claim 1 further comprising on said nodes with a plurality of said Synapses, with the property that said plurality is generally proportional to the overall compute-performance of a node.

5. The method of SPP as described in claim 1 on said network is a Wide Area Network (WAN) over a plurality of Local Area Networks (LANs) as sub-networks, said SPL on said XSB synchronized over each said LAN with the property that said atomic updating is by full handshaking between Synapses and a daemon running on said XSB on any of said LANs, said daemon releasing said line items from said SPL in response to requests received from said Synapses on the basis of first-come, first serve.
